(19) United States
(12) Patent Application Publication
(10) Pub. No.: US 2026/0134294 A1
(43) Pub. Date: May 14, 2026

(54) SYSTEMS AND METHODS FOR QUALITY ASSESSMENT FOR LARGE LANGUAGE MODELS (LLMs) BASED ON CONSISTENCY QUANTIFICATION

(71) Applicant: Q2 Software, Inc., Austin, TX (US)

(72) Inventors: Maria Alejandra Escalante Perez, Toronto (CA); Cameron Christopher Farr Plouffe, Toronto (CA); Daniel Wagner, Thornhill (CA)

(21) Appl. No.: 19/379,399

(22) Filed: Nov. 4, 2025

Related U.S. Application Data
(60) Provisional application No. 63/718,324, filed on Nov. 8, 2024.

(51) Int. Cl. G06N 3/10

(52) U.S. Cl. CPC G06N 3/10

(57) ABSTRACT

Systems and methods for LLM assessment are disclosed herein. Embodiments may provide a quality assessment of an LLM that is based on the consistency of that LLM. Utilizing response sampling, pairwise similarity, and an uncertainty score, embodiments may measure response consistency, which can be correlated with output quality for an LLM.

### RELATED APPLICATIONS

This application claims a benefit of priority under 35 U.S.C. § 119 to U.S. Provisional Patent Application No. 63/718,324 filed Nov. 8, 2024, entitled “SYSTEMS AND METHODS FOR QUALITY ASSESSMENT FOR LARGE LANGUAGE MODELS (LLMs) BASED ON CONSISTENCY QUANTIFICATION,” which is hereby fully incorporated by reference in its entirety.

### TECHNICAL FIELD

This disclosure relates generally to computing systems for data extraction and representation. Specifically, this disclosure relates to computer systems that employ natural language processing, machine learning, large language models (LLMs), or structured data extraction. Even more particularly, this disclosure relates to assessing the quality of the LLMs in such computing systems, including the use of such LLMs in a particular context or with a particular system.

### BACKGROUND

The use of large language models (LLMs) has grown rapidly. Accordingly, LLMs have been integrated into a wide variety of systems used in a wide variety of contexts. LLMs have proved especially useful for tasks involving extracting information from documents. Tools designed to automate and streamline this data extraction and checking have thus been developed. These tools may effectively employ LLMs to perform such data extraction or checking. The use of these LLMs in these data extraction system (and other systems) is, however, not without its attendant problem. Namely, many LLMs function as black boxes, meaning their internal decision-making processes are not easily accessible or interpretable. Moreover, many LLMs exhibit non-determinism, in other words, such LLMs may produce different outputs for the same input under similar conditions. This non-determinism may arise, at least in part, from the probabilistic nature of LLMs. These dual qualities and inconsistencies lead to a number of issues especially in production-grade systems where users may expect consistent or stable results.

The non-determinism in LLMs may lead to inconsistency in results or outputs, making it difficult to rely on systems that use LLMs for stable and repeatable results. This variability, combined with the effort required for labeling reference data, makes traditional quality and accuracy metrics for such LLMs (or systems that employ LLMs) less effective for many use cases. This issue becomes even more pronounced in complex tasks, such as named entity extraction with long contexts and structured responses.

What is desired, therefore, is to provide a reliable assessment of the quality of LLMs.

### SUMMARY

To continue with the above discussion, prior LLM evaluation methods for data extraction tasks—automatic, human, and LLM-based—each face limitations. Automatic metrics, like cosine similarity, often misalign with human judgment and require reference data, which isn't always available. Human evaluation is inconsistent, labor-intensive, and varies across evaluators, while LLM-based methods, though promising, introduce more nondeterminism and bias toward model-generated content. Moreover, most solutions focus on short-context tasks, making them unsuitable for long, complex documents.

Accordingly, despite the lack of consensus, as LLMs become more ubiquitous in production grade systems, the need for trustworthy ways to assure quality in LLM output has grown. The current literature on the topic focuses on mainly three different approaches for evaluating these LLMs as discussed: automatic, human, and LLM based. The first (automatic) approach typically works by using two texts as an input to the LLM: one to be evaluated, and one to be used as a reference. The problem with these methods is that they are inconsistent and do not always correlate with human evaluation. The second approach, human evaluation, is both time consuming and inaccurate. The third approach, LLM-based evaluation of an LLM, or LLM-as-a-judge, still suffer from the same nondeterminism that all other LLM-based applications suffer from, which causes scoring of quality assessment to vary despite the fact that the responses being evaluated stay the same.

As can be seen then, there are no standardized and effective methods for evaluating LLMs. To ameliorate these issues, among others, embodiments of the systems and methods for LLM assessment disclosed herein may provide a quality assessment of an LLM that is based on the consistency of that LLM. Specifically, embodiments may utilize response sampling, pairwise similarity, and a consistency metric to measure response consistency of the LLM. This consistency can be correlated with output quality for an LLM. Embodiments of methods and systems which employ these techniques can be adapted to various tasks by modifying pairwise similarity requirements and tuning the relationship between quality and consistency for particular applications.

For desired applications, embodiments may employ an automated monitoring tool that periodically samples documents (e.g., of a corpus such as a test corpus which may be comprised of documents selected from a live corpus being used by a system), applies embodiments to determine a consistency metric for an LLM, determines a quality metric based on the consistency metric, and alerts users if the quality metric falls below a set threshold. As such, embodiments may enable proactive issue detection with systems that employ LLMs.

In one embodiment, quality of an LLM may be assessed by obtaining content of a document and generating multiple outputs of the LLM based on the content of the document, wherein each of the multiple outputs comprises output generated from the LLM based on multiple submissions of the content of the document to the LLM. This output can, for example, be a structured output. Each submission may, for example, utilize a same prompt. Such a prompt may, for instance, specify a schema to be utilized for the structured output of the LLM. Additionally, in some embodiments each submission of the content to the LLM utilizes a new context. A consistency metric can be generated for the LLM by comparing the multiple outputs of the LLM generated from the submissions of the content of the document to the LLM. A quality metric for the LLM can then be generated based on the consistency metric.

In some embodiments, the quality metric for the LLM is generated from the consistency metric by applying a relationship factor determined between the consistency metric and the quality metric.

In certain embodiments, generating the consistency metric comprises generating a pairwise similarity between each pair of the multiple outputs. The pairwise similarity for a pair of outputs is based on a comparison of the output associated with each of the pair. The consistency metric is based on this pairwise similarity. Generating the consistency metric can also include generating a dissimilarity matrix based on the pairwise similarity. Thus, in particular embodiments, the consistency metric is based on the eigenvalues of the graph Laplacian determined based on the dissimilarity matrix.

Embodiments thus offer several advantages over previous solutions by enabling reliable, label-free quality estimation for long-context, structured tasks without requiring access to LLM model weights. Unlike traditional methods, which rely on time-intensive labeling or inconsistent LLM-based scoring, embodiments may use response consistency as a quality proxy, allowing for efficient, scalable monitoring. This creates value by reducing manual evaluation costs and enhancing the reliability of production systems, ensuring consistent quality for end users. For the users, embodiments may be used to provide an automated monitoring tool that detects potential issues early, leading to faster troubleshooting and better alignment with client expectations in critical applications.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a block diagram depicting one embodiment of a system and method for quality assessment for LLMs.

FIG. 2 is a block diagram depicting one embodiment of a system for quality assessment for LLMs.

FIG. 3 is a flow diagram for one embodiment of a method for quality assessment for LLMs.

FIG. 4 is one example of structured text.

FIG. 5 is one example of a prompt for entity extraction.

FIGS. 6A-6C are examples of structured output of an LLM.

FIG. 7 is pseudo code for one embodiment of a method for comparing structured outputs of an LLM.

FIG. 8 is a depiction of different distributions of dissimilarity matrices.

FIG. 9 is a graphical representation of an example relationship between certainty and quality.

FIG. 10 is a block diagram of one embodiment of system including a monitoring system utilizing an LLM assessment system.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. Skilled artisans should understand, however, that the detailed description and the specific examples, while disclosing preferred embodiments of the invention, are given by way of illustration only and not by way of limitation. Various substitutions, modifications, additions or rearrangements within the scope of the underlying inventive concept(s) will become apparent to those skilled in the art after reading this disclosure.

The use of large language models (LLMs) for data extraction or summarization in a variety of contexts has become increasingly popular due to their applicability to natural language. Accordingly, LLMs have been integrated into a wide variety of systems used in a wide variety of contexts. LLMs have proved especially useful for tasks involving extracting information from long context data such as and converting it into a structured response, such as named entity extraction or relationship extraction. These tasks may be viewed as a more complex form of Named Entity Recognition (NER).

For example, such information extraction may provide especially useful in situations that involve large amounts of paperwork or clerical tasks that must be completed. While essential, these tasks take significant time and attention away from the parts of the process where a human is truly needed. One of the biggest issues arises when key information (e.g., in the context of loan documents, things such as interest rates, borrower names, loan amounts, amortization periods, etc.) fail to match across documents (e.g., again in the loan context, loan applications, agreements, credit memos, term sheets, etc.). These discrepancies may delay processes involving such documents, as corrections are made, often multiple times. This iterative, manual checking consumes a great deal of time and frustrates both bankers and clients.

Tools designed to automate and streamline this data extraction and checking have thus been developed. These tools may effectively employ LLMs to perform such data extraction or checking. The use of these LLMs in these data extraction systems (and other systems) is, however, not without its attendant problem. Namely, many LLMs function as black boxes, meaning their internal decision-making processes are not easily accessible or interpretable. Moreover, many LLMs exhibit non-determinism, in other words, such LLMs may produce different outputs for the same input under similar conditions. This non-determinism may arise, at least in part, from the probabilistic nature of large language models. These dual qualities and inconsistencies lead to a number of issues, especially in production-grade systems where users may expect consistent or stable results.

To illustrate in more detail, one significant issue with the use of LLMs is a lack of transparency. Users cannot easily understand why an LLM (or a system using such an LLM) made a particular decision or produced a specific output. This lack of insight can hinder trust, especially in critical applications like finance or healthcare, where understanding the rationale behind decisions is essential. The non-determinism in LLMs may lead to inconsistency in results or outputs, making it difficult to rely on systems that use LLMs for stable and repeatable results. For instance, the same document might be summarized differently each time it is processed. Commensurately, then, validating outputs from LLMs becomes complex.

This variability, combined with the effort required for labeling reference data, makes traditional quality and accuracy metrics for such LLMs (or systems that employ LLMs) less effective for many use cases. This issue becomes even more pronounced in complex tasks, such as named entity extraction with long contexts and structured responses.

Prior LLM evaluation methods for data extraction tasks—automatic, human, and LLM-based—each face limitations. Automatic metrics, like cosine similarity, often misalign with human judgment and require reference data, which isn't always available. Human evaluation is inconsistent, labor-intensive, and varies across evaluators, while LLM-based methods, though promising, introduce more nondeterminism and bias toward model-generated content. Moreover, most solutions focus on short-context tasks, making them unsuitable for long, complex documents.

Accordingly, despite the lack of consensus, as LLMs become more ubiquitous in production grade systems, the need for trustworthy ways to assure quality in LLM output has grown. The current literature on the topic focuses on mainly three different approaches for evaluating these LLMs as discussed: automatic, human, and LLM based.

The first (automatic) approach typically works by using two texts as an input to the LLM: one to be evaluated, and one to be used as a reference. Thus this technique usually involves embedding-based metrics like cosine similarity that evaluate the semantic similarity between the model's output and a reference answer. For instance, BLUBERT leverages pretrained transformers (like BERT) to compare generated and reference texts at a deeper semantic level. The problem with these methods is that they are inconsistent and do not always correlate with human evaluation. Additionally, these types of methodologies require reference data to compare to, which is not readily available in many applications.

The second approach, human evaluation, is both time consuming and inaccurate. Even when consistently using a rubric and the same humans for evaluation, the uncertainty and accuracy varies from person to person, especially as the task complexity increases, Additionally, defining an evaluation rubric for an LLM is usually an iterative process that requires humans to start evaluating without any pre-defined rules to determine what should be included in the rubric. The process involves multiple iterations until a standardized rubric is established, requiring all previously labeled data to be relabeled to reflect the refined criteria. This has led to the combination of both human and automatic evaluation techniques, which have also proved insufficient.

The third approach, LLM-based evaluation of an LLM, or LLM-as-a-judge, has recently gained more favor. Some techniques use black box LLMs such as GPT4 for the assessment of an LLM, while other techniques focus on fine tuning open source LLMs to create a more accurate judge for their specific tasks for LLM evaluation, but in general, the process is the same. A prompt with predefined standards for the response is given to the LLM alongside the output of the LLM under evaluation, then, the evaluating LLM responds with a score or metric to score the given output.

The idea behind these types of methods is thus to leverage the instruction following capabilities of LLMs to evaluate the output of other LLMs. Despite being promising, these methods suffer from the same nondeterminism that all other LLM-based applications suffer from, which causes scoring of quality assessment to vary despite the fact that the responses being evaluated stay the same. Other challenges to these methods may be self-enhancement or self-preference bias, which is when an LLM judge favors LLM-generated answers.

It is also important to note that most existing LLM evaluation techniques have primarily been validated for assessing models on short context data (e.g., input prompt, text or conversation histories that are well within an LLMs maximum context window). For instance, it has been shown that most LLMs struggle with longer context tasks, and that existing techniques for LLM evaluation like chain-of-thought and in-context learning, which perform well with the use of LLMs in association with short contexts, may struggle significantly with the use of longer contexts in association with LLMs. Thus, in many cases, even techniques for LLM evaluation that may perform acceptably with respect to short context data may fail or provide inadequate results when utilized to evaluate LLMs that are used in conjunction with processing tasks which involves very complex prompts or contexts (e.g., extraction tasks for long or complex document pages).

As can be seen then, there are no standardized and effective methods for evaluating LLMs. Most existing approaches depend on labeled data, are time-consuming and labor-intensive, or use LLM-based evaluations, which introduce nondeterminism and randomness into the quality evaluation process. Moreover, labeled data may not be effectively utilized in many contexts for such an evaluation task, since in many cases, labeled data that is similar to the data being processed by the LLM cannot be obtained and labeled due to the proprietary and private nature of that data (e.g., loan or other financial documents, medical records, etc.).

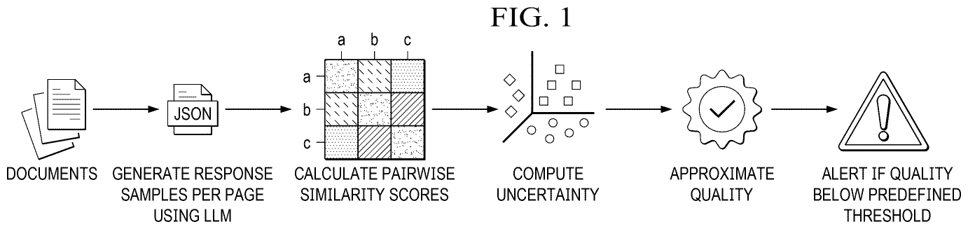

To address those deficiencies, among others, and to provide a reliable assessment of the quality of LLMs, embodiments of the systems and methods for LLM assessment disclosed herein may provide a quality assessment of an LLM that is based on the consistency of that LLM's output. As shown in FIG. 1, embodiments as disclosed may address the problem of evaluating LLM output quality for structured, long-context entity extraction tasks by introducing a novel, consistency-based method that estimates quality without manual labeling or access to model weights. Through response sampling, pairwise similarity, and an uncertainty score, embodiment may measure response consistency, which can be correlated with output quality for an LLM. Embodiments of methods and systems which employ these techniques can be adapted to various tasks by modifying pairwise similarity requirements and tuning the relationship between quality and consistency for particular applications. For desired applications (e.g., that employ an LLM), embodiments may employ an automated monitoring tool that periodically samples documents (e.g., of a corpus such as a test corpus which may be comprised of documents selected from a live corpus being used by a system or application), applies embodiments to determine a consistency metric for an LLM, determines a quality metric based on the consistency metric, and alerts users if the quality metric falls below a set threshold. As such, embodiments may enable proactive issue detection with systems that employ LLMs.

Embodiments thus offer several advantages over previous solutions by enabling reliable, label-free quality estimation for long-context, structured tasks without requiring access to LLM model weights. Unlike traditional methods, which rely on time-intensive labeling or inconsistent LLM-based scoring, embodiments may use response consistency as a quality proxy, allowing for efficient, scalable monitoring. This creates value by reducing manual evaluation costs and enhancing the reliability of production systems, ensuring consistent quality for end users. For the users, embodiments may be used to provide an automated monitoring tool that detects potential issues early, leading to faster troubleshooting and better alignment with client expectations in critical applications.

To illustrate in more detail, to assess LLM quality, embodiments may obtain multiple outputs of the LLM for each document of a set of test documents. Each of the multiple outputs for a document may comprise the output of the LLM applied to that document. Thus, each of the multiple outputs may result from a submission of the document (e.g., at least a portion of the content of the document) to the LLM. Each of the set of test documents may be one of a set of documents (or a portion of a document) that may have been provided or processed by a user of a system that incorporates the LLM whose quality it is desired to assess.

To facilitate the comparison of outputs from the LLM, the responses (output) generated by the LLM may be generated according to a (e.g., the same) structured format (e.g., as JavaScript Object Notation (JSON)). This structured format may comprise an identification of entities in the document along with a location for where each of those entities were found in the document. Thus, a same prompt may be used for each application of the LLM to the document, where the prompt includes text of the document and a specification of the (e.g., JSON) schema to be used for the returned output. Moreover, in some cases, the application of the LLM to the document may be initiated with a new (e.g., independent of previous) context to avoid influencing a response of the LLM with any previous context.

To aid in the identification of the location in the document in the output of the LLM, the text of the document may be provided in a graph or other structure formatted such that it identifies the location of the text of the document. The location may be, for example, a page and line number associated with that text. Such a text structure may be generated, for example, through the application of Optical Character Recognition (OCR) to a document (e.g., a PDF version of the document).

A pairwise similarity may be determined between outputs of the LLM for the document. For example, for each pair of outputs of LLM in the set of outputs for each application of the LLM to the document (e.g., each permutation of two outputs from the set of outputs) a pairwise similarity may be determined. This pairwise similarity may be determined by comparing the differences between the (entities and locations included in the) JSON of each output. The pairwise similarities for each pair of outputs of the LLM for a document may thus comprise a dissimilarity matrix for that document. This pairwise similarity may be run in each direction to generate two similarity scores and selecting one of the two similarity scores (e.g., comparing a first output to a second output to generate one similarity score, and comparing the second output to the first output to generate a second similarity score, and selecting between the two similarity scores, such as the highest or lowest score).

Using the dissimilarity matrix determined for each of the test documents, a consistency metric can be determined for the LLM. This consistency metric may be a measure of the consistency of the outputs generated by the LLM for a (e.g., the same) document. This consistency metric can be the sum of the eigenvalues in the graph Laplacian (also known as the trace of the Laplacian). In the context of a dissimilarity matrix, calculating the eigenvalues of the graph Laplacian may thus provide information about the connectivity and cluster structure of the data and how spread out data is across the graph. Higher eigenvalues generally indicate less cohesive clusters or groups.

A quality metric for the LLM can then be determined from the consistency metric. The quality metric can be determined by applying a relationship factor to the consistency metric to generate the quality metric. This relationship factor may be determined, for example, by establishing a relationship between consistency metrics and quality metrics based on a subset of data samples that may be labeled with expected responses. This labeling process creates a ground truth for evaluating the quality of the LLM's outputs. The quality of each response is quantified by comparing it against the labeled example using the pairwise similarity measures, resulting in an average quality score for each sample. Having both the quality and consistency scores for each sample, the relationship between them can be found and used to determine a relationship factor that allows a quality metric to be calculated from the consistency metric (e.g., based on consistency for new/unseen samples).

As may be realized, a quality metric for an LLM may thus be determined based on the use of a single document. In certain cases, however, it may be desirable to generate a (e.g., overall) quality metric for the LLM using quality metrics determined for the LLM based on each of the set of documents of a test corpus. Here, a quality metric may be determined for each document of the test corpus and a quality metric heuristic (e.g., algorithm) applied to determine the (e.g., overall) quality metric for the LLM. This heuristic may entail averaging the quality metrics determined for each document of the test corpus, selecting a highest or lowest quality metric of the determine quality metrics, weighting certain quality metrics for particular documents, etc.

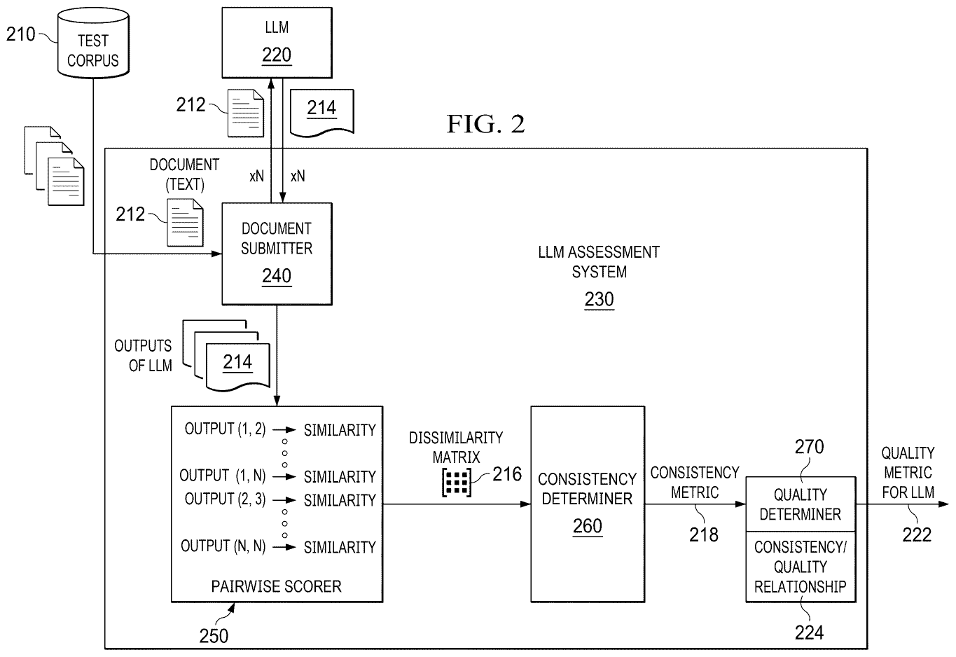

FIG. 2 depicts one embodiment of a system for LLM assessment. Here, a test corpus 210 may comprise one or more documents (e.g., any electronic file that may include text or other content) that will be used to assess LLM 220. LLM assessment system 230 may thus generate a quality metric for LLM 220 using documents of test corpus 210. Initially a document 212 of the test corpus 210 may be obtained by LLM assessment system 230. Document submitter 240 may obtain multiple (e.g., N) outputs 214 of the LLM 220 for document 212 of the test corpus 210 by submitting the document 212 to the LLM 220 multiple times (e.g., N times) using the same prompt. Each of the multiple outputs 214 for document 212 will comprise the output of the LLM 220 applied to that document 212.

To facilitate the comparison of outputs 214 from the LLM, the responses (output) 214 generated by the LLM 220 may be generated according to a (e.g., the same) structured format (e.g., as JavaScript Object Notation (JSON)). This structured format may comprise an identification of entities in the document along with a location for where each of those entities was found in the document. Thus, a same prompt may be used by document submitter 240 for each submission of document 212 to the LLM 220, where the prompt includes text of the document 212 and a specification of the (e.g., JSON) schema to be used for the returned output.

To aid in the identification of the location in the document 212 in the output 214 of the LLM 220, the text of the document may be provided in the prompt to the LLM 220 in a graph or other structure formatted such that it identifies the location of the text of the document. The location may be, for example, a page and line number associated with that text. Such a text structure may be generated, for example, through the application of Optical Character Recognition (OCR) to document 212 (e.g., a PDF version of the document).

The set of outputs 214 obtained for the multiple submission of the document 212 to the LLM 220 can then be provided to pairwise scorer 250. Pairwise scorer 250 can determine a pairwise similarity between outputs 214 of the LLM 220 for the document 212. For example, for each pair of outputs 214 of LLM 220 in the set of outputs for each submission of the document 212 to LLM 220 (e.g., each permutation of two outputs from the set of outputs) a pairwise similarity may be determined. This pairwise similarity may be determined by comparing the differences between the (entities and locations included in the) JSON of each output. The pairwise similarities for each pair of outputs of the LLM for a document may thus comprise (or be used to form) a dissimilarity matrix 216 for that document.

Consistency determiner 260 may use the dissimilarity matrix 216 determined from the outputs 214 of LLM 220 for the multiple submissions of document 212 to LLM 220 to determine a consistency metric 218 for the LLM 220. This consistency metric 218 may be a measure of the consistency of the LLM 220 based on the outputs 214 of the LLM 220. This consistency metric 218 can be the sum of the eigenvalues in the graph Laplacian (also known as the trace of the Laplacian). In the context of a dissimilarity matrix 216, calculating the eigenvalues of the graph Laplacian may thus provide information about the connectivity and cluster structure of the data and how spread out data is across the graph. Higher eigenvalues generally indicate less cohesive clusters or groups.

A quality metric 222 for the LLM 220 can then be determined from the consistency metric 218 by quality determiner 270. The quality metric 222 can be determined by applying a relationship factor 224 to the consistency metric 218 to generate the quality metric 222. This relationship factor 224 may be determined, for example, by (e.g., asynchronously) establishing a relationship between consistency metrics and quality metrics based on a subset of data samples that may be labeled with expected responses. Other methods for determining such a relationship factor 224 may be utilized (e.g., manual configuration, using models to establish such a relationship, etc.) and are fully contemplated here.

As will be discussed in more detail, embodiments of an LLM assessment system such as that depicted in FIG. 2 may be incorporated into, or used in conjunction with, virtually any system or platform that employs an LLM (e.g., to process documents) to assess the quality of that LLM. Such quality assessments may thus be used for a variety of purposes, including retraining or replacing the LLM utilized to improve the quality of such systems or platforms.

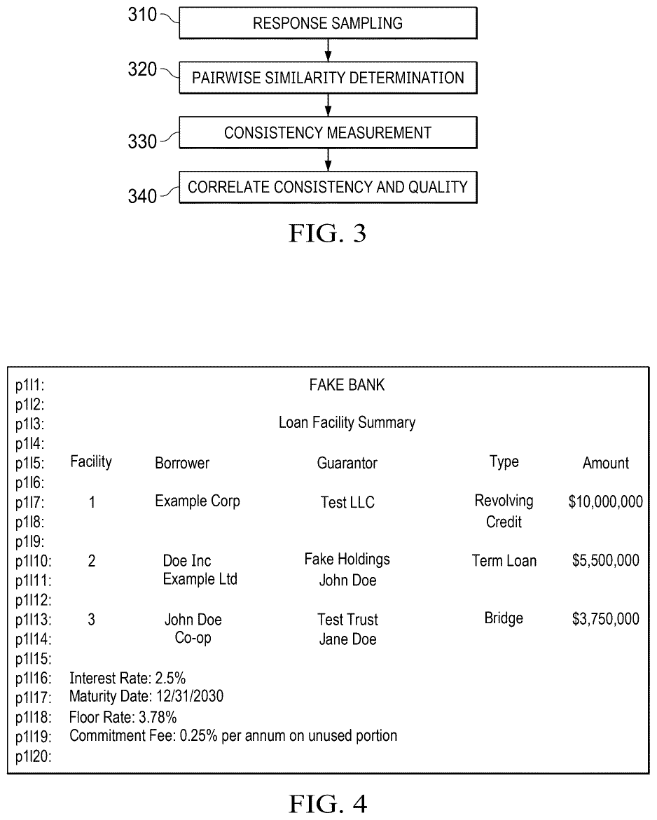

FIG. 3 is a flow diagram depicting one embodiment of a method for generating a quality assessment metric for an LLM by evaluating multiple responses generated by the LLM on the same document. In certain cases, embodiments may operate with an understanding or assumption that an LLM (e.g., the LLM under evaluation) already performs reasonably well and accurately for the task at hand (e.g., the context in which it is being employed).

In one embodiment, the method may include response sampling (STEP 310), pairwise similarity calculation (STEP 320), consistency measurement (STEP 330), and correlating consistency and quality (e.g., determining a quality metric from a consistency metric) (STEP 340). Initially, response samples may be generated (STEP 310). Here, for each sample of data (e.g., documents from a corpus), a predefined number (e.g., 30) of response samples may be generated. The responses are produced by executing the LLM (for which a quality assessment is being determined) multiple times (e.g., on the same document) with the same prompt. The responses in the LLM may be in a structured data format such as JSON. This can be done by defining a schema and adding that to the LLM prompt with instructions to use that as the output format. Thus, the LLM will generate an output according to that schema in the LLM prompt.

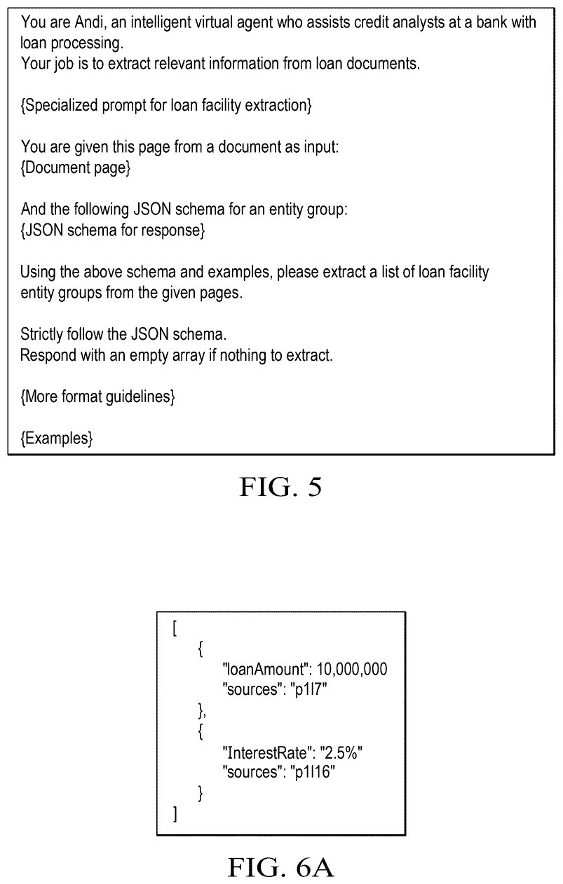

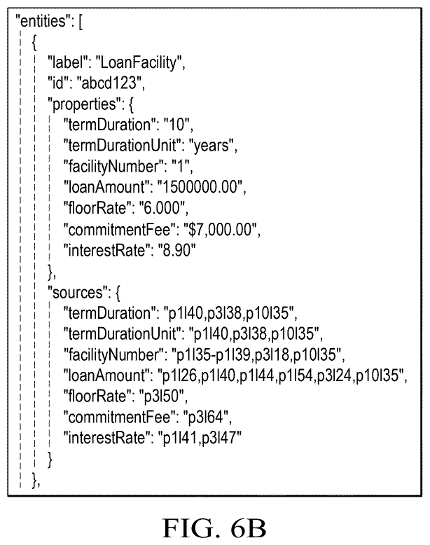

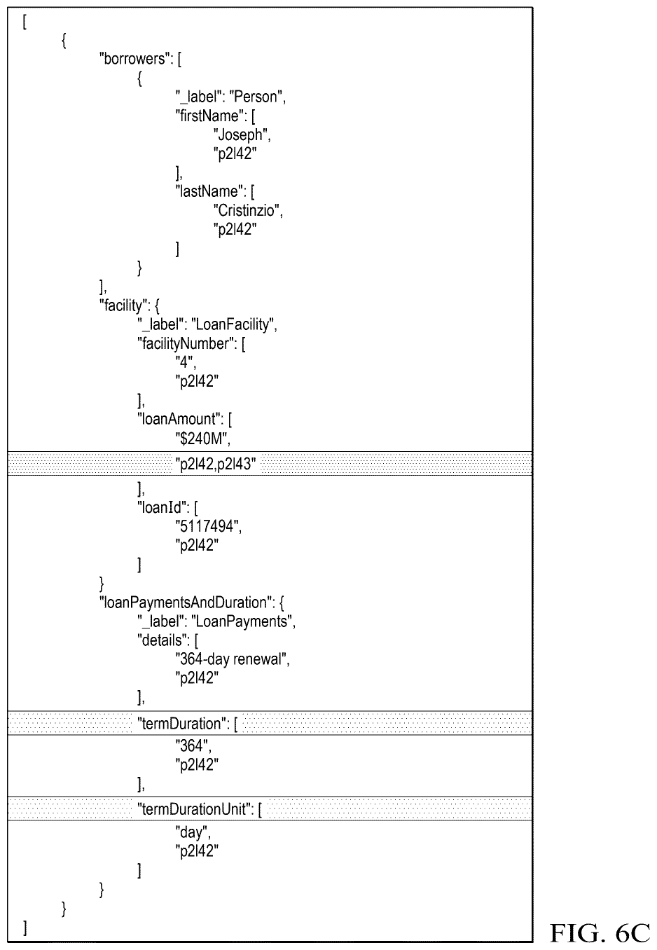

For example, text may be extracted from a document (e.g., one or more pages of a document) using OCR and formatted as shown in FIG. 4. The text is structured with page number and page line to be able to ascertain where corresponding data was found in the document. Following this extraction, the text of the document in this format is passed to the LLM along with a JSON schema to utilize to return the response including entities or other data found in the text. One example of such a prompt is depicted in FIG. 5. The output of the LLM is thus returned in the JSON format specified in the prompt and included extracted entities and the source or location where that entity was found in the document. Examples of such JSON is shown in FIGS. 6A, 6B and 6C.

Next, a pairwise similarity determination may be performed (STEP 320). This determination may produce a dissimilarity matrix, where each entry indicates the degree of similarity between the responses for a document obtained from the LLM (e.g., from the LLM as generated in STEP 310), enabling visualization of variability across samples. The metric to measure the similarity between responses may depend on the application and the type of response being used.

In some embodiments, this pairwise similarity is determined utilizing the JSON responses obtained from the LLM (e.g., in response to each submission of the document). While Jaccard similarity and Natural Language and Inference may be utilized to calculate pairwise similarity between a pair of responses, these may be less useful for a structured and complex output of an LLM such as that utilized by embodiments where the returned JSON may include arrays, dictionaries, text, etc.

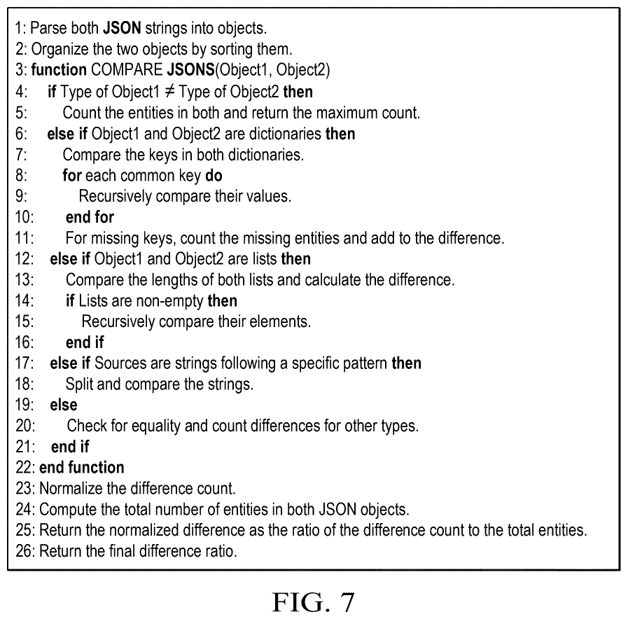

In certain embodiments then, a pairwise similarity between two outputs from the LLM (e.g., for the same document) may comprise organizing the JSON outputs and iteratively comparing the extracted entities (e.g., and their locations included in the JSON response). During this process, the number of differences between the two JSON responses may be tracked and returned when the lowest level of the JSON is finally compared. This process can be performed in both directions—comparing the first response (e.g., JSON 1) to the second response (e.g., JSON 2), and vice versa—and then selecting the higher (or lower) of the two results. This may be done to account for length differences in the responses. Finally, the selected number (e.g., the selected value for the pairwise similarity) is normalized by dividing it in the number of total extracted entities (in this context, entities are referred to as both keys and values of the JSON). Pseudocode for one embodiment of a method for performing a determination of pairwise similarity is depicted in FIG. 7.

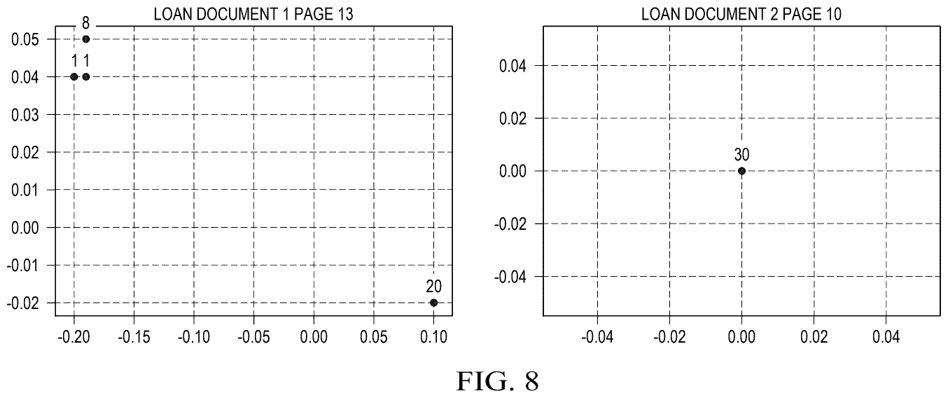

After running this pairwise similarity for the pairs of outputs, a dissimilarity matrix is produced for the document, where the diagonal is 0, indicating comparisons of an object to itself, and values greater than 0 in position (i, j) indicate the difference of the outputs (i, j). Examples of a dissimilarity matrix that results from the process above after applying multidimensional scaling to visualize the data in a lower dimensional space can be seen in FIG. 8. These graphs allows the visualization of how some pages have only one response for the (e.g., 30) runs, while other documents have much more variability and split into several clusters. Each graph may correspond to a page in a document, and each point is one of the responses sampled from the LLM. The distance between points represent how different responses are to one another.

A consistency measurement may then be determined (STEP 230). One approach to generating a consistency measurement may comprise counting the number of unique responses generated by the LLM (e.g., for a document). However, such an approach may not account for how those responses are distributed. For instance, if 30 responses were sampled and one document had two equally distributed response groups, while the samples from another document had an uneven distribution (e.g., 29 vs. 1), the latter should be considered far more consistent, as it predominantly includes the same response. Another approach could involve using clustering techniques. However, these methods often introduce some degree of randomness (as seen in k-means clustering) or may require setting a clustering threshold to define group boundaries (as in hierarchical clustering).

As such, certain embodiments may employ methods for determining a consistency metric based on the sum of the eigenvalues in the graph Laplacian (also known as the trace of the Laplacian). In the context of a dissimilarity matrix, determining the eigenvalues of the graph Laplacian can provide information about the connectivity and cluster structure of the data, and how spread out data is across the graph.

Since in some embodiments, a similarity score may reflect the dissimilarity between two outputs from the LLM, a first step may be to convert the dissimilarity matrix (M) into a similarity matrix (W):

$$W = 1 - M$$

Then, a degree matrix D may be constructed using the similarity matrix W, where each entry Dᵢᵢ represents the sum of similarities connected to node i:

$$D = diag ( {\sum }_{j} {W}_{i j} )$$

Following this, a Laplacian matrix can be constructed. The graph Laplacian L is computed using the formula:

$$L = I - {D}^{1 / 2} W {D}^{- 1 / 2}$$

where I is the identity matrix.

The eigenvalues of the Laplacian matrix can then be determined through decomposition:

$$L = Q ∧ {Q}^{- 1}$$

where Λ is a diagonal matrix of eigenvalues, and Q is the matrix of eigenvectors. This provides insight into the structural properties of the data.

The final consistency metric (or uncertainty) is calculated using the formula:

$$uncertainty = \frac{1}{n} {\sum }_{i = 1}^{n} max ( 0 , 1 - {λ}_{i} )$$

where λᵢ are the eigenvalues, and n is the number of data points (or nodes).

At this point, consistency and quality may be correlated (STEP 340). Specifically, a quality metric for the LLM can then be determined from the consistency metric. The quality metric can be determined by applying a relationship factor to the consistency metric to generate the quality metric. This relationship factor 224 may be determined, for example, by (e.g., asynchronously) establishing a relationship between consistency metrics and quality metrics based on a subset of data samples that may be labeled with expected responses.

To establish a relationship between consistency and quality, a subset of data samples may be labeled with the expected responses. This labeling process creates a ground truth for evaluating the quality of the LLM's outputs. The quality of each response is quantified by comparing it against the labeled example using the pairwise similarity measures, resulting in an average quality score for each sample. Having both the quality and consistency scores for each sample the relationship between them can be found and used to approximate quality (e.g., based on consistency for new/unseen samples).

For example, labeling may comprise manually writing an expected or desired JSON response or responses for a document. For comparing consistency and quality, it may be desirable to do a the same size or level comparison as will be used to generate a consistency score. For the scoring system, each JSON sample for a document may be compared to the labeled example (e.g., the manually generated JSON) using the proposed pairwise similarity, and the average of those scores defined as the quality score of the document. These quality scores can then be correlated with consistency scores generated for these documents to generate the relationship factor.

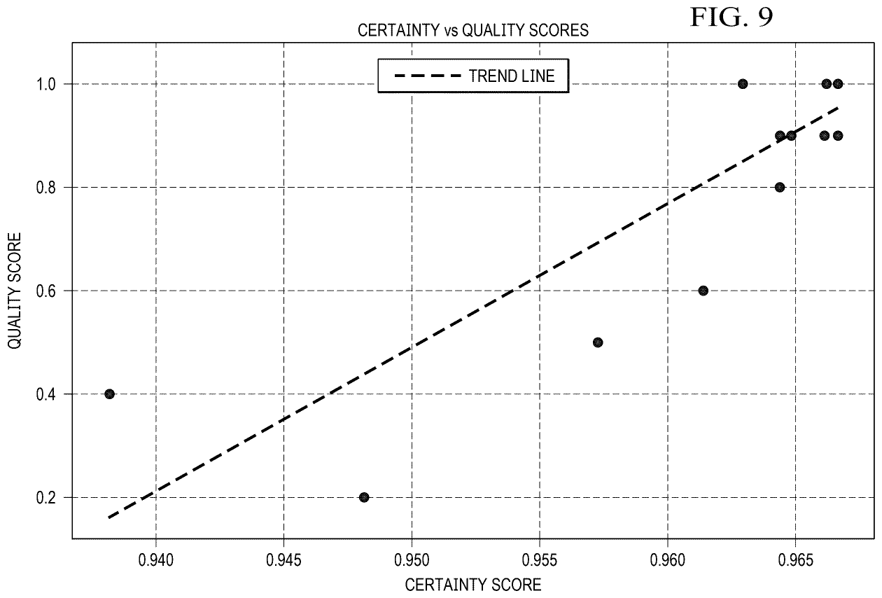

As can be seen in FIG. 9, as uncertainty decreases, the quality measurement may also increase. Another important insight is that a small drop in certainty causes a huge drop in quality. In the graph, the certainty drops from 0.96 to 0.95 which causes a drop in quality from 0.7 to 0.5. This means that having consistent responses may be very important for assuring quality in certain applications or uses of an LLM assessment system.

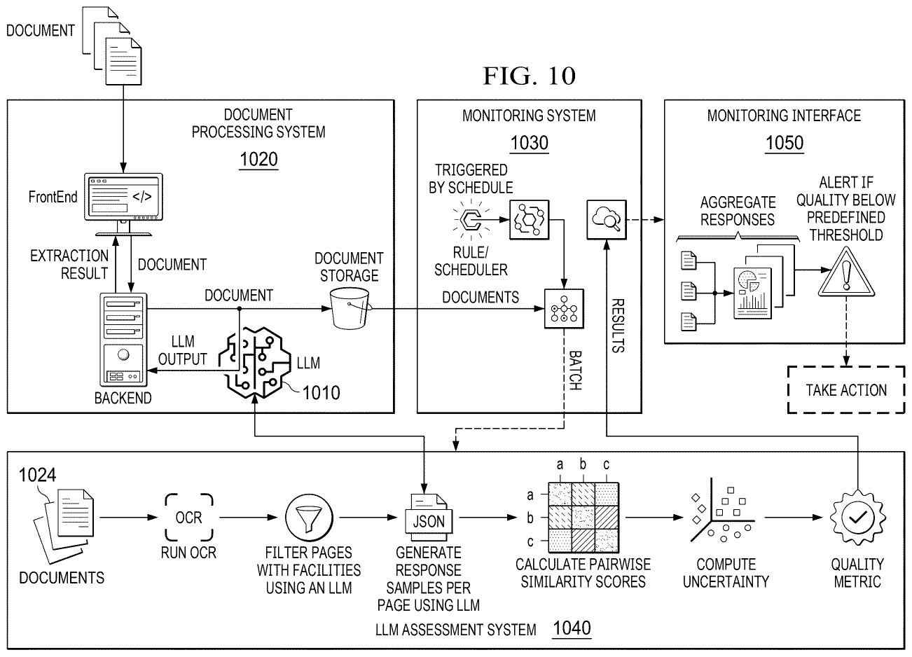

As mentioned previously, embodiments of an LLM assessment system may be usefully incorporated into, or used in conjunction with, virtually any system or platform that employs an LLM (e.g., to process documents) to assess the quality of that LLM. FIG. 10 depicts an embodiment of an LLM assessment system utilized to monitor an LLM utilized in association with document processing system. Here, document processing system 1020 may utilize an LLM to process documents by, for example, using LLM 1010 to extract entities from documents for various purposes. Thus, documents are provided to the document processing system (e.g., through a front end) and the LLM 1010 is used to extract data (e.g., entities) that may be presented through the front end or otherwise utilized in a variety of manners by document processing system 1020. Thus, in many cases LLM 1010 may be utilized to extract information, such as entities and relationships from long-context data, and convert it into a structured representation.

For example, document processing system 1020 may be a tool designed to automate and streamline repetitive and intensive tasks. As but one specific case, obtaining a loan is often a tedious and time-consuming process for the parties involved. Loan providers frequently find themselves bogged down by clerical tasks that, while essential, take significant time and attention away from the parts of the process where a human is truly needed. One of the biggest issues arises when key information—such as interest rates, borrower names, loan amounts, or amortization periods—fails to match across documents like loan agreements, credit memos, and term sheets. These discrepancies force the loan process to backtrack, delaying approval as corrections are made, often multiple times. This iterative, manual checking consumes a great deal of time and frustrates both bankers and clients.

Thus, a document processing system 1020 may be a tool designed to automate and streamline such tasks. Document processing system 1020 may thus employ an LLM 1010 to allow users to provide (e.g., loan) documents and automatically verify that crucial information matches across these documents. This reduces the need for manual checks, speeding up the process significantly.

For example, document processing system 1020 may include a loan extraction tool that leverages LLMs to extract information from provided documents (e.g., PDFs) into a (e.g., graph) data structure to make it easy to identify inconsistencies between documents. The document processing system 1020 may thus extract the text from loan agreements, term sheets, memos, or other documents using OCR and formats it as described herein including a page number or line number.

A prompt is then constructed to pass the formatted extracted test to LLM 1010 which returns its response in a structured (e.g., JSON) format. The extraction contains entities such as loan amount, interest rate, and borrower name, and the sources to where it was found in the document. Document processing system 1020 can then compare different documents based on a comparison of the outputs of the LLM 1010 from these documents.

No matter the context of use of document processing system 1020, like all LLM-based systems, document processing system 1020 may be hampered by the inherent issue of nondeterminism, where results from the LLM 1010 can vary slightly from one run to the next. This variability posed a challenge for creating a reliable benchmark for quality, as the LLM's outputs could fluctuate enough to cause significant differences in precision—sometimes by as much as 10%.

Specifically, the extraction step where the document processing system 1020 extracts data from documents using LLM 1010 is where the uncertainty and nondeterministic behavior of LLM 1010 may hamper the performance of document processing system 1020. For certain documents, LLM 1010 may sometimes return a very high-quality (e.g., JSON) extraction, while other times, the LLM 1010 may miss important information (e.g., such as a sources or complete loan facilities).

Even in cases where an LLM temperature is set to 0 to limit the randomness of the LLM 1010, this may not be the only source of nondeterminism. Additionally, switching the underlying LLMs 1010 used by document processing system 1020 (e.g., such as from Anthropic Claude 3.5 to OpenAI 4.0) may lead to variations in performance and quality. This creates challenges, as LLM updates can introduce inconsistencies, while on the other hand, not updating the LLM 1010 risks missing improvements that could enhance other aspects of the extraction process of document processing system 1020. Moreover, the performance of extraction across different documents varies significantly, posing a challenge since document creators may utilize diverse formats, styles, and language not only between enterprises but also within the same enterprise.

What is desired then, is to provide a tool that monitors the outputs of LLM 1010 (or results produced by that LLM) to automatically detect potential drops in quality. As such, embodiments may include a monitoring system 1030 that utilizes an LLM assessment system 1040 to track quality of LLM 1010 to proactively detect and correct issues with LLM 1010 utilized by document processing system 1020.

Specifically, monitoring system 1030 may include an automated monitoring tool to approximate and measure quality of LLM 1010 and provide alerts for potential issues. The monitoring system 1030 may operate by sampling pages from the documents being processed by document processing system 1020 and forming a test corpus to provide to LLM assessment system 1040 to generate a quality metric for LLM 1010.

Accordingly, as documents are being processed by document processing system 1020, they may be stored by document processing system 1020. At some interval or based upon some triggering event (e.g., interval based or schedule based), monitoring system 1030 may sample (e.g., randomly or based on some criteria) a set of the documents processed by document processing system 1020 (e.g., documents processed over a most recent or previous interval if using interval-based evaluation).

These sampled documents 1024 may then be provided to LLM assessment system 1040 to generate a quality metric for LLM 1010. As discussed, the generation of this quality assessment metric may entail the running of OCR on these documents to extract the text from documents (e.g., according to a structured format). In some embodiments, the sampled documents of the test corpus may be filtered (e.g., using an LLM which may be the same or different than LLM 1010) to remove certain documents that may be undesirable for use in determining a quality metric, that may be duplicative, or for other reasons. This text of a document of the test corpus may then be used to generate a quality metric for LLM 1010 (e.g., by performing response sampling, pairwise similarity calculation, determining a consistency metric, and determining a quality metric from the consistency metric).

One or more quality metrics (e.g., a quality metric determined based on one or more documents of the test corpus) or an overall quality metric (e.g., determined based on quality metrics from individual documents of the test corpus) may be provided to monitoring system 1030. It will be noted here that in some cases, document processing system 1020 may be utilized by multiple enterprises (e.g., the document processing system 1020 may be a “multi-tenant” system). In this case, this quality metric determination process may be repeated using different test corpuses, where each test corpus may comprise documents associated with a particular enterprise (e.g., tenant) that utilizes document processing system 120. Thus, quality metrics may be determined in association with each enterprise (e.g., tenant) that utilizes document processing system 1020. In these instances, each of these quality metrics for each enterprise may be provided to monitoring system 1030 or may be used in determining an overall quality metric for LLM 1010. Thus, a quality metric for LLM 1010 for each individual enterprise that utilizes document processing system 1020 can be determined and utilized by monitoring system 1030, or an overall quality metric that reflects the performance of LLM 1010 across all enterprises that utilize document processing system 1020 may also (or alternatively) be determined and utilized by monitoring system 1030.

This monitoring system 1030 can present such quality metrics through a monitoring interface 1050. Additionally or alternatively, a quality metric may be compared to a threshold, and if the predicted quality falls below that threshold, an alert may be triggered through the monitoring interface 1050 or another action taken. When such a drop in quality occurs, it could indicate several possibilities. For example, a drop in quality could indicate a system-wide issue: if the quality decreases across many enterprises (e.g., the quality metric for each enterprise all drop), the problem is likely tied to recent code updates or changes in the LLM 1010. If, however, a significant quality drop is isolated to a single enterprise while the quality metric for other enterprises does not drop significantly, it may indicate the need for fine-tuning or preprocessing adjustments (e.g., to the LLM 1010, a LLM prompt, the document processing system 1020) for that specific enterprise.

As can be seen, one key advantage of embodiments of an LLM monitoring tool such as that disclosed, is that it may be fully automated, eliminating the need for ongoing manual labeling of documents. Such a monitoring tool seamlessly integrates with a document processing system continuously evaluating the quality of an LLM (e.g., used for extraction) without requiring intervention. This automation not only saves considerable time and effort, but also ensures a consistent, objective assessment of performance. Additionally, the monitoring tool is highly scalable, easily accommodating larger volumes of data as the workload changes. Moreover, since a monitoring tool may operate on demand or at an interval, the frequency of its execution can be adjusted according to desired monitoring needs. For example, running the monitoring tool more frequently allows for the early detection of quality issues, enabling faster responses to potential problems.

Those skilled in the relevant art will appreciate that the invention can be implemented or practiced with other computer system configurations including, without limitation, cloud deployed computing systems or servers (E.g., either physical or virtual), multi-processor systems, network devices, mini-computers, mainframe computers, data processors, and the like. The invention can be embodied in a general-purpose computer, or a special purpose computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, or the Internet.

In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature, or function, including any such embodiment, feature, or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a set of distributed computers communicatively coupled to a network (for example, the Internet). Any suitable programming language can be used to implement the routines, methods, or programs of embodiments of the invention described herein, including C, C++, Java, JavaScript, HTML, or any other programming or scripting code, etc. Other software/hardware/network architectures may be used. Communications between computers implementing embodiments can be accomplished using any electronic, optical, radio frequency signals, or other suitable methods and tools of communication in compliance with known network protocols.

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways or methods to implement the invention.

A “computer-readable medium” may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

What is claimed is:

1. A system for assessing quality of a Large Language Model (LLM), comprising:
a processor; and
a non-transitory computer readable medium, comprising instructions for:
obtaining content of a document;
generating multiple outputs of the LLM based on the content of the document, wherein each of the multiple outputs comprises output generated from the LLM based on multiple submissions of the content of the document to the LLM using a same prompt;
generating a consistency metric for the LLM by comparing the multiple outputs of the LLM generated from the submissions of the content of the document to the LLM; and
generating a quality metric for the LLM based on the consistency metric.

2. The system of claim 1, wherein the quality metric for the LLM is generated from the consistency metric by applying a relationship factor determined between the consistency metric and the quality metric.

3. The system of claim 2, wherein each submission of the content to the LLM utilizes a new context.

4. The system of claim 2, wherein the output generated from the LLM is structured.

5. The system of claim 4, wherein generating the consistency metric comprises generating a pairwise similarity between each pair of the multiple outputs based on a comparison the output of each of the pair of the multiple outputs, and the consistency metric is based on the pairwise similarity.

6. The system of claim 5, wherein generating the consistency metric comprises generating a dissimilarity matrix based on the pairwise similarity.

7. The system of claim 6, wherein generating the consistency metric is based on the eigenvalues of the graph Laplacian determined based on the dissimilarity matrix.

8. A method for assessing quality of an Large Language Model (LLM), comprising:
obtaining content of a document;
generating multiple outputs of the LLM based on the content of the document, wherein each of the multiple outputs comprises output generated from the LLM based on multiple submissions of the content of the document to the LLM using a same prompt;
generating a consistency metric for the LLM by comparing the multiple outputs of the LLM generated from the submissions of the content of the document to the LLM; and
generating a quality metric for the LLM based on the consistency metric.

9. The method of claim 8, wherein the quality metric for the LLM is generated from the consistency metric by applying a relationship factor determined between the consistency metric and the quality metric.

10. The method of claim 9, wherein each submission of the content to the LLM utilizes a new context.

11. The method of claim 9, wherein the output generated from the LLM is structured.

12. The method of claim 11, wherein generating the consistency metric comprises generating a pairwise similarity between each pair of the multiple outputs based on a comparison the output of each of the pair of the multiple outputs, and the consistency metric is based on the pairwise similarity.

13. The method of claim 12, wherein generating the consistency metric comprises generating a dissimilarity matrix based on the pairwise similarity.

14. The method of claim 13, wherein generating the consistency metric is based on the eigenvalues of the graph Laplacian determined based on the dissimilarity matrix.

15. A non-transitory computer readable medium, comprising instructions for:
obtaining content of a document;
generating multiple outputs of the LLM based on the content of the document, wherein each of the multiple outputs comprises output generated from the LLM based on multiple submissions of the content of the document to the LLM using a same prompt;
generating a consistency metric for the LLM by comparing the multiple outputs of the LLM generated from the submissions of the content of the document to the LLM; and
generating a quality metric for the LLM based on the consistency metric.

16. The non-transitory computer readable medium of claim 15, wherein the quality metric for the LLM is generated from the consistency metric by applying a relationship factor determined between the consistency metric and the quality metric.

17. The non-transitory computer readable medium of claim 16, wherein each submission of the content to the LLM utilizes a new context.

18. The non-transitory computer readable medium of claim 16, wherein the output generated from the LLM is structured.

19. The non-transitory computer readable medium of claim 18, wherein generating the consistency metric comprises generating a pairwise similarity between each pair of the multiple outputs based on a comparison the output of each of the pair of the multiple outputs, and the consistency metric is based on the pairwise similarity.

20. The non-transitory computer readable medium of claim 19, wherein generating the consistency metric comprises generating a dissimilarity matrix based on the pairwise similarity.

21. The non-transitory computer readable medium of claim 20, wherein generating the consistency metric is based on the eigenvalues of the graph Laplacian determined based on the dissimilarity matrix.
